(19) United States
(12) Patent Application Publication
(10) Pub. No.: US 2026/0270670 A1
(43) Pub. Date: Sep. 10, 2026

(54) Use of Advertisement Messaging to Establish Synchronization Channel Configuration for Connectionless Phase-Based Ranging

(71) Applicant: Google LLC, Mountain View, CA (US)

(72) Inventors: Li-Xuan Chuo, San Jose, CA (US); Qi Jiang, San Jose, CA (US); Yung-Tsung Chen, New Taipei City (TW); Daniel Jose Fernandes Barros, Porto (PT)

(21) Appl. No.: 19/167,205

(22) PCT Filed: Mar. 31, 2023
(86) PCT No.: PCT/US2023/065190

§ 371 Date: Sep. 19, 2025

(51) Int. Cl. H04W 4/80

(52) U.S. Cl. CPC H04W 4/80

(57) ABSTRACT

A method and apparatus to help facilitate Bluetooth Low Energy (BLE) Multi-Carrier-Phase Difference (MCPD) ranging between a first device and the second device. An example method includes the first device engaging in an exchange of BLE advertisement messaging with the second device. Further, the method includes the including in the BLE advertisement messaging a set of data defining a sync-channel configuration for a synchronization process to help facilitate the BLE MCPD ranging between a first device and the second device, the including of the set of data in the BLE advertisement messaging facilitating communication of the set of data between the first device and the second device without a need for the first device and second device to establish a BLE connection with each other through which to communicate the set of data. In addition, the method includes the first device using the sync-channel configuration for the synchronization process.

### BACKGROUND

An electronic device may be equipped with ranging technology that enables the device to determine how far away from the device another device is located, and perhaps where the other device is positioned (e.g., an orientation of the distance). This ranging technology may help facilitate various useful features.

For example, the ranging may help facilitate determining which one or more devices are nearby, to facilitate proximity-based sharing of photos or other content with select nearby devices. For instance, a user's device may engage in ranging to identify each other device that is within a predefined threshold close distance to the user's device and may then present on a display, for the user to see, the identity of each identified nearby device, to allow the user to decide which nearby device(s) to share content with.

As another example, the ranging may help facilitate person-to-person meetups, such as helping to guide users toward each other. For instance, a first user's device may apply ranging to determine how far away a second user's device is located and to determine an angle at which the second user's device is located in relation to an orientation of the first user's device. Based on the results of that ranging, the first user's device may then present on a display, for the first user to see, a graphical depiction of distance and direction to the second user's device, and the first user may then conveniently use that graphical depiction as a basis to move closer to the second user.

As still another example, the ranging may help facilitate unlocking of a secure system. For instance, a user's device may include a digital key that enables unlocking of a secure system such as a car or a house and that is configured to unlock the secure system only if and when the user's device is close enough to the secure system, such as when the user's device is positioned within a predefined threshold short distance from the secure system. In that case, the user's device may apply ranging to determine how close the user's device is to the secure system and, responsive to determining from that ranging that the user's device is close enough to the secure system, may then allow use of the digital key to unlock the secure system.

Other examples are possible as well.

### SUMMARY

One type of ranging technology that is of particular interest given the Bluetooth radio found in many devices today is Bluetooth High Accuracy Distance Measurement (HADM) (also referred to as Bluetooth Channel Sounding (CS)).

HADM, operating with the Bluetooth Low Energy (BLE) protocol, itself makes use of a procedure called Multi-Carrier Phase Difference (MCPD), which involves measuring the phase shift respectively of each of multiple predefined Bluetooth tones transmitted between the devices and determining the distance between the devices based on a difference between those phase shifts. For instance, at each of multiple Bluetooth channels (i.e., predefined Bluetooth frequencies), one device functioning as an “initiator” may transmit a constant tone signal to the other device functioning as a “reflector,” the reflector may responsively transmit the same constant tone signal on the same Bluetooth channel back to the initiator, and the initiator may determine a phase shift by comparing the phase of the received constant tone signal with the phase of the transmitted constant tone signal. Using known mathematical relationships between distance and difference in phase shifts computed at various frequencies, the initiator may then compute the distance between it and the reflector with a high degree of accuracy.

To facilitate a ranging process such as HADM, the devices may first need to engage in a discovery process to learn that they are in close enough proximity to each other, and the devices may then need to establish and maintain a BLE connection with each other through which they can share information related to the ranging process.

To do this in a typical arrangement, the reflector may advertise its presence by repeatedly broadcasting a BLE advertisement message, namely an ADV_IND message, on certain predefined BLE channels (e.g., with periodicity of 20 milliseconds (ms) to 10.24 seconds), and the initiator may scan those channels for presence of this advertisement message. The ADV_IND message may carry an address of the reflector and a Protocol Data Unit (PDU) type code designating the message as an ADV_IND message indicating that the reflector may be available to accept connections. Once the initiator discovers this ADV_IND message from the reflector, the initiator may then determine based on the received strength of the message (e.g., received signal strength indicator (RSSI)) that the reflector is close enough to facilitate ranging.

Upon determining that the reflector is close enough to facilitate ranging, the initiator and reflector may then exchange directed advertisement messaging with each other to facilitate their establishment of a BLE connection. In particular, the devices may exchange additional advertisement messages with each other that have capacity to carry more information, such as their respective profile and service-support information or the like, that the devices may use as a basis to decide whether to connect with each other.

Under BLE, for instance, the initiator may transmit to the address of the reflector a SCAN_REQ message that carries an address of the initiator, a PDU type designating the message as a scan request, and possibly other useful data. The reflector may then respond to this SCAN_REQ message by transmitting to the address of the initiator a SCAN_RSP message that carries the address of the reflector and a PDU type designating the message as a scan response, and possibly other useful data. (Further, in some cases, the initiator and reflector may also exchange auxiliary scan request and response advertisement messages with each other, possibly on one or more secondary advertising channels. For instance, the initiator may send to the reflector an AUX_SCAN_REQ message, and the reflector may respond to the initiator with an AUX_SCAN_RSP message.) Once the initiator decides that it would like to connect with the reflector, the initiator may then transmit to the address of the reflector a CONNECT_REQ message, which may function to establish a BLE connection between the devices.

With this BLE connection established, the initiator and reflector may then engage in the HADM process, possibly using their BLE connection as a basis to agree with each other on parameters of the HADM process and to share results of the HADM process with each other.

As noted above, the HADM process may involve transmission of constant tone signals between the devices at various BLE channels and using a difference in phase shift of those signals on those various channels as a basis to determine distance. The specifics of this process may vary from implementation to implementation.

Without limitation, in one example implementation, the devices may conduct this process across the entire set of available BLE channels. For instance, if there are 40 BLE channels, with three reserved as advertising channels, the devices may conduct the process across the remaining 37 BLE channels. Further, the devices may divide those channels into groups and conduct the HADM process separately per group to compute a respective distance determination per group, and the initiator may combine (e.g., average) those distance determination to establish a representative distance determination.

As to each group of BLE channels, the initiator may cycle through the channels, engaging ping-pong signaling with the reflector and computing an associated phase shift. For instance, on each BLE channel, (i) the initiator may use a local oscillator to generate a constant tone signal at the center frequency of the channel and may transmit that constant tone signal as a “ping” signal to the reflector, (ii) the reflector may then use a local oscillator to generate a constant tone signal at the same frequency and may transmit that constant tone signal as a “pong” signal to the initiator, and (iii) the initiator may then compare its transmit phase of the ping signal with the receive phase of the pong signal in order to determine a phase shift for that BLE channel. Carrying out this process successively for each BLE channel of the group, the initiator may then compute a difference in phase shift as to pairs of the BLE channels. And based on the computed differences in phase shift, the initiator may compute a distance between the devices. In an alternative arrangement, the reflector may carry out certain aspects of this analysis, such as phase-shift and/or phase-shift-difference evaluation, among other possibilities.

This HADM process assumes tight synchronization of frequency and timing between the initiator and the reflector. Unfortunately, however, the local oscillators and clocks of the initiator and reflector may not be sufficiently synchronized with each other. Therefore, it may be best for the devices to engage in a synchronization process with each other before they engage in their ping-pong signaling exchange and the associated distance determination. For instance, it may be best for the devices to engage in this synchronization process as an initial step respectively for each group of BLE channels on which they will engage in ranging.

This synchronization process may involve the devices engaging in an exchange of sync signaling with each other on a designated sync channel. This sync channel may be a particular one of the BLE channels that is designated for use as the sync channel (possibly one of the BLE channels that the devices will also use for ranging in the HADM process), among other possibilities.

For instance, one device may use its local oscillator to generate a constant tone signal as a sync signal on the center frequency of the sync channel and may transmit that sync signal to the other device. The other device as recipient device may then receive this transmitted sync signal but may determine that the frequency of the signal as received is offset from what it perceives to be the center frequency of the sync channel. The recipient device may therefore determine a fractional frequency offset as a difference between received frequency of the sync signal and expected frequency of the sync signal, and the recipient device may then set itself to apply that determined frequency offset to bias its subsequent ping-pong signal exchanges with the first device. Further, the sync signal may also carry a bit pattern that the recipient device could use as a basis to calculate a clock/timing offset for use to compensate timing between the two devices as well.

In some implementations, for security and/or other reasons, the devices may alternatively spread their sync signaling over multiple sync channels, e.g., multiple particular BLE channels designated as sync channels. For instance, the devices may spread their sync signaling over two or three sync channels. With this arrangement, for example, the devices may engage in signaling on one sync channel to establish the fractional frequency offset, and the devices may engage in signaling on another sync channel to synchronize their timing, among other possibilities.

In addition, the devices may include in their sync signaling with each other one or more access codes or the like, which could help limit the sync signaling to be read by just the desired recipient device. For instance, if the initiator is going to transmit a sync signal to a particular reflector, the initiator may include in the sync signal an access code specific to that reflector, to help ensure that just that reflector, and no other reflector, processes the sync signal.

To facilitate their synchronization process, the devices may need to agree in advance on a sync-channel configuration, i.e., the devices may need to establish one or more parameters defining a configuration of their synchronization process. In an example implementation, the sync-channel configuration may include at a minimum a designation of which one or more BLE channels the devices will use as their sync channel(s), i.e., the BLE channel(s) on which they will engage in the synchronization process. Further, the synch-channel configuration may also include one or more other parameters if applicable, such as what access code(s) the devices will use for their sync signaling and/or what sync channel map the devices will use for their sync signaling, among other possibilities.

In practice, the devices could agree on their sync-channel configuration through communication with each other within their established BLE connection. Unfortunately, however, establishing and maintaining such a BLE connection may be technically complicated and undesirable in some scenarios, such as when the initiator is going to engage in HADM ranging with multiple other reflectors at once.

The present disclosure provides a mechanism to facilitate having the devices establish their sync-channel configuration without a need to establish a BLE connection.

In one respect, for instance, disclosed is an example method. The method includes a first device engaging in an exchange of BLE advertisement messaging with a second device, with the engaging in the exchange of BLE advertisement messaging including the first device transmitting to the second device a BLE scan request message and receiving in response from the second device a BLE scan response message. Further, the method includes the first device including in the BLE advertisement messaging a set of data defining a sync-channel configuration for a synchronization process to help facilitate BLE MCPD ranging between the first device and the second device, with the including of the set of data in the BLE advertisement messaging facilitating communication of the set of data between the first device and the second device without a need for the first device and second device to establish a BLE connection with each other through which to communicate the set of data. In turn, the method then involves the first device using the sync-channel configuration for the synchronization process.

In another respect, disclosed is an example device. The device includes a Bluetooth radio, a processor, non-transitory data storage, and program instructions stored in the non-transitory data storage and executable by the processor to carry out operations such as those of the example method.

In yet another respect, disclosed is a non-transitory computer-readable medium having stored thereon program instructions executable by a processor of a device to cause the device to carry out operations such as those of the example method.

In still another respect, disclosed is a system that includes various means for carrying out each of the operations described herein.

These as well as other aspects, advantages, and alternatives will become apparent to those of ordinary skill in the art by reading the following detailed description, with reference where appropriate to the accompanying drawings. Further, it should be understood that the descriptions provided in this summary and below are intended to illustrate the invention by way of example only and not by way of limitation.

### BRIEF DESCRIPTION OF THE DRAWINGS

FIG. 1 is a simplified block diagram illustrating an example arrangement and process where an initiator may engage in HADM ranging with one or more reflectors, making use of disclosed features.

FIG. 2 is an illustration of an example Bluetooth packet carrying HADM sync-channel configuration information.

FIG. 3 is a simplified block diagram of an example device.

FIG. 4 is a flow chart illustrating an example method.

### DETAILED DESCRIPTION

As noted above, one way that an initiator and reflector can establish a sync-channel configuration for their synchronization process is to agree on the configuration through communication with each other within their established BLE connection.

For instance, in their established BLE connection, the initiator may transmit to the reflector a set of data defining HADM sync-channel configuration information. This HADM sync-channel configuration information could include specifications of the above configuration parameters, such as one or more sync channel identifiers defining one or more BLE channels that the devices will use as their sync channel(s), one or more access codes that the devices will use in their sync signaling, and a sync channel map that the devices will use for their sync signaling. The reflector may thus receive this HADM sync-channel configuration information from the initiator within their BLE connection and may transmit to the initiator an acknowledgement of the configuration. Further, in view of this exchange, the initiator and reflector may set themselves to operate with the indicated sync-channel configuration.

Once the devices have thereby established their sync-channel configuration, the devices may then proceed accordingly, engaging in the synchronization process and thereafter engaging in the MCPD ranging process. For instance, the devices may first engage in sync signaling with each other on their agreed one or more sync channels in order to become frequency and time synchronized with each other, and the devices may then proceed with their ping-pong ranging signaling on multiple BLE channels, with the initiator computing phase shifts and evaluating phase-shift difference and, ultimately, determining a distance between the devices.

In an example arrangement, as noted above, if the devices will carry out the HADM ranging process separately for each of multiple groups of BLE channels, the devices may engage in this synchronization process as an initial step respectively for each group of BLE channels. For instance, as to each group of BLE channels, the devices may first communicate with each other through their BLE connection to establish a sync-channel configuration for their synchronization process, the devices may then engage in their synchronization process with the established sync-channel configuration, and the devices may then engage in their ping-pong ranging signaling with each other, with the initiator computing phase shifts, evaluating phase-shift difference, and determining distance.

While the above process may work well in practice to facilitate determination of distance between devices, one aspect of the process that may actually pose a technical challenge as noted above is having the devices establish and maintain a BLE connection with each other.

As discussed above, it may be desirable for the initiator and reflector to have a BLE connection through which they can share information related to their HADM ranging process. For instance, the devices could communicate with each other through the BLE connection as noted above to establish a sync-channel configuration as noted above, possibly as an initial step for each of multiple separate groups of BLE channels on which they will engage in HADM ranging. Further, in some HADM ranging implementations, the devices may exchange other ranging-related information with each other, such as encryption or other security parameters to be used for their ping-pong ranging signaling, as well as phase measurements and/or resulting distance determinations, among other possibilities.

Unfortunately, however, having the initiator and reflector establish and possibly maintain a BLE connection with each other as a precursor to their ping-pong ranging signaling may be problematic. To begin with, when the initiator and reflector enter into a BLE connection with each other, the initiator and/or reflector may present on a display an indication of being Bluetooth connected with each other, which may pose a user-experience issue if the devices are merely temporarily Bluetooth connected to facilitate the ranging process. Further, in a scenario where an initiator will engage in ranging with multiple reflectors at once, possibly to determine which reflectors are threshold close to the initiator (e.g., to justify proximity-based photo sharing), it could be very complicated, processor-intensive, and power-intensive for the initiator to establish and maintain multiple BLE connections, one respectively with each reflector of the multiple reflectors.

As noted above, the present disclosure provides a technical mechanism that may help to overcome this problem. In particular, the disclosure provides an improved mechanism for an initiator and reflector to agree on their sync-channel configuration without a need for the devices to establish a BLE connection or other such connection with each other.

In accordance with the disclosure, the devices will instead communicate their sync-channel configuration information with each other by including the information within advertisement messaging that the devices would normally exchange with each other to facilitate establishing a connection with each other.

In particular, with the arrangement discussed above, the devices could communicate their sync-channel-configuration information with each other by including the information in the SCAN_REQ and/or SCAN_RSP advertisement messaging that the devices would exchange with each other to facilitate establishing a BLE connection with each other (and/or perhaps in AUX_SCAN_REQ and/or AUX_SCAN_RSP advertisement messaging that the devices may likewise exchange with each other). For instance, after the initiator discovers an ADV_IND message broadcast from the reflector, when the initiator then transmits to the reflector a SCAN_REQ message, the initiator may include within the SCAN_REQ message a set of data defining HADM sync-channel configuration information, and the reflector may include within the SCAN_RSP message an acknowledgement of receipt of that sync-channel configuration information.

In an example implementation, the SCAN_REQ and SCAN_RSP messages may also carry the information that those messages would carry as discussed above, such as the address information for instance. Therefore, the SCAN_REQ and SCAN_RSP messages may also still work as discussed above to facilitate establishing a BLE connection between the devices if desired. However, the devices may or may not then actually establish that BLE connection with each other. For instance, the initiator may or may not then transmit a CONNECT_REQ message to the reflector. Regardless, by communicating their sync-channel configuration information within the SCAN_REQ and/or SCAN_RSP advertisement messaging, the devices could proceed to engage in the HADM process, making use of the communicated sync-channel configuration information to facilitate their synchronization process and then proceeding with their ping-pong ranging signaling to facilitate distance determination.

In an example implementation, the devices may altogether forgo establishing a BLE connection with each other, thus making their HADM ranging process fully connectionless. While not establishing a BLE connection with each other might mean that the devices may forgo exchanging certain information with each other that they may otherwise exchange through the BLE connection, some ranging use-cases may still work fine.

For instance, although the devices might sometimes exchange encryption or other security parameters with each other through their BLE connection, some use-cases may not need that level of security and may therefore work fine without an exchange of that security information. Further, although the devices may sometimes exchange their measurement or ranging results with each other through their BLE connection, some use-cases may not call for that exchange of information and may likewise work fine without the exchange of that information. (In addition, the devices may be able to use other mechanisms, possibly also the advertising messaging, to communicate these or other pieces of information.) Other examples may be possible as well.

In addition to helping avoid the need for the initiator and reflector to establish a BLE connection through which to communicate their sync-channel configuration information, the process of the devices communicating their sync-channel configuration information with each other within BLE advertisement messaging can also conveniently enable the initiator to establish a separate sync-channel configuration respectively for each of multiple reflectors with which the initiator will engage in HADM ranging.

For instance, if the initiator discovers presence of multiple reflectors and will engage in HADM ranging respectively with each reflector, the initiator may conveniently use its SCAN_REQ and SCAN_RSP advertisement signaling with the various reflectors as a basis to establish a different sync-channel configuration per reflector. By way of example, the initiator may establish one or more different sync channels to use respectively per reflector, one or more different access codes to use respectively per reflector, and/or one or more different access channel maps to use respectively per reflector.

Thus, the HADM sync-channel configuration information that the initiator sends in a SCAN_REQ message to one reflector can differ from the sync-channel configuration information that the initiator sends in a SCAN_REQ message to another reflector. In this way, for instance, the initiator may be able to coordinate possibly concurrent synchronization processes with the multiple reflectors while avoiding conflicts and confusion by arranging for each synchronization process to occur on one or more different sync channels than each other and/or to have other different sync-channel configurations than each other.

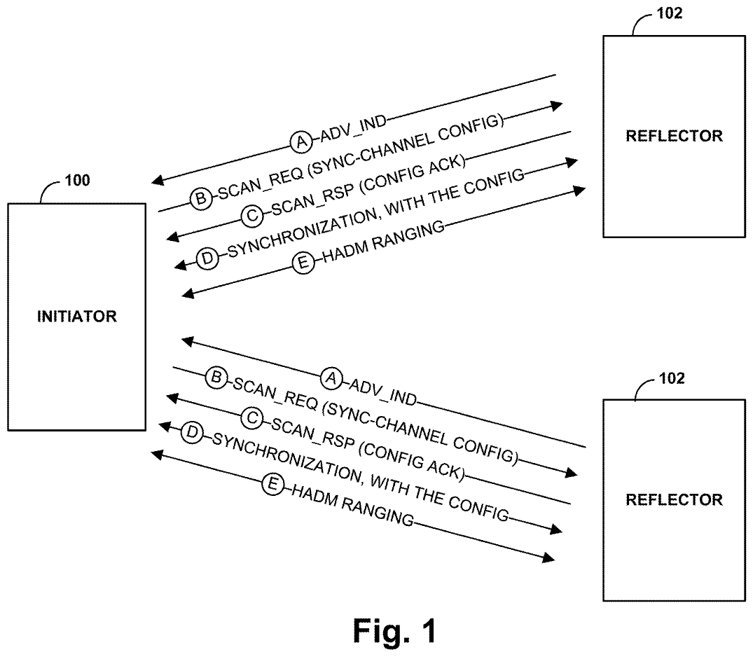

FIG. 1 is a simplified block diagram illustrating an example arrangement and process where an initiator 100 may engage in HADM ranging with one or more reflectors 102, making use of the present advance.

In the example arrangement of FIG. 1, the initiator 100 may first respond to user input or another trigger by scanning for the presence of nearby devices, particularly monitoring one or more predefined BLE advertising channels for the presence of ADV_IND messages. As a result, at step A, the initiator 100 may receive and detect an ADV_IND message broadcast respectively from each of the illustrated reflectors 102.

For each reflector's ADV_IND that the initiator 100 determines is sufficiently strong, the initiator 100 may then engage in a SCAN_REQ/SCAN_RSP exchange with the reflector 102. In particular, at step B, the initiator 100 may transmit to the reflector 102 a SCAN_REQ message, and at step C, the initiator 100 may receive from the reflector 102 a SCAN_RSP message.

In line with the discussion, as further shown, the initiator 100 may conveniently include within its SCAN_REQ message respectively to each reflector 102 a set of data defining a HADM sync-channel configuration information indicating one or more parameters for a synchronization process that the initiator 100 and the reflector 102 will carry out to facilitate their HADM ranging process. And each reflector 102 may include in its SCAN_RSP message to the initiator 100 an acknowledgement of the noted sync-channel configuration.

Further, as discussed above, the initiator 100 may provide different such sync-channel configuration information respectively in its SYNC_REQ message to each reflector 102, such as specifying respectively for each reflector 102 one or more different sync channels to be used for the synchronization process between the initiator 100 and the reflector 102 and/or specifying one or more other different parameters to be used for the synchronization process between the initiator 100 and the reflector 102.

At step D, the initiator 100 may then engage in the synchronization process respectively with each reflector 102, using the established sync-channel configuration. As discussed above, for instance, this process may involve sync signaling passing between the initiator 100 and the reflector on the one or more designated sync channels, and the initiator 100 and/or reflector 102 using the sync signaling as a basis to establish a fractional frequency offset and/or clock timing and setting itself to operate accordingly during ping-pong ranging communication between the devices.

At step E, the initiator 100 may then engage in HADM ranging signaling, such as the MCPD process, respectively with each reflector 102. For instance, successively on each of various BLE channels, the initiator 100 may transmit a constant tone signal ping to the reflector 102, the reflector 102 may transmit a constant tone signal pong to the initiator 100, and the initiator 100 may determine an associated phase shift, and the initiator 100 may evaluate phase-shift difference between pairs of these channels as a basis to determine a distance between then devices.

Having thereby determined the distance respectively between the initiator and each of the one or more reflectors 102, the initiator 100 may then carry out any of various associated actions. For instance, the initiator 100 may use that determined distance information as a basis to facilitate proximity-based photo sharing or other content sharing, the initiator 100 may use the determined distance information as to multiple reflectors as a basis to estimate a relative location of the initiator 100, and/or the initiator may use the determined distance information as a basis to unlock a secure system, among other possibilities.

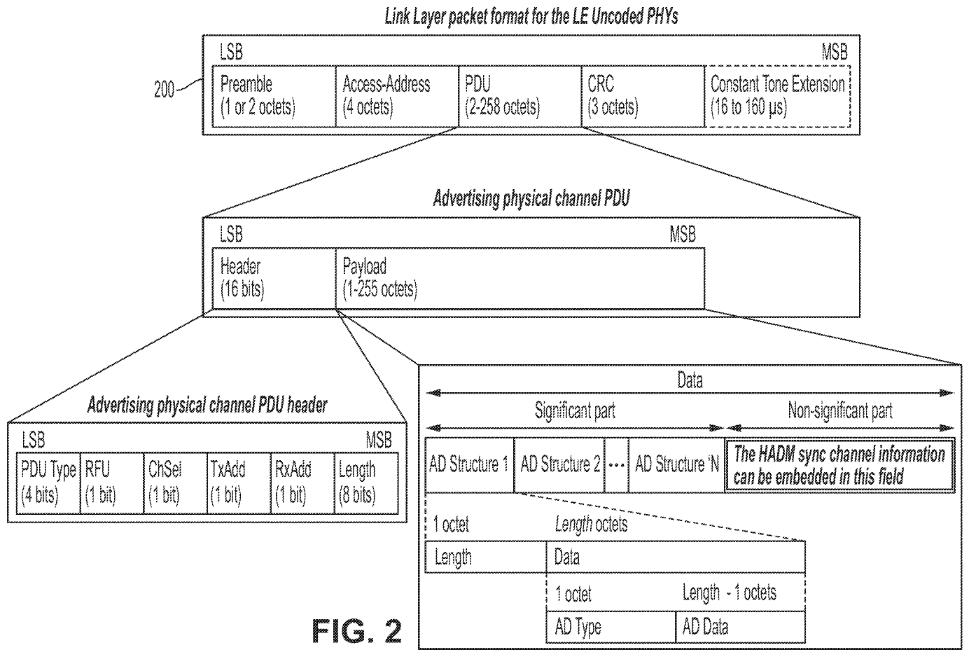

FIG. 2 illustrates an example structure of a Bluetooth packet, such as a SCAN_REQ message, that could be used to carry the HADM sync-channel configuration data in line with the discussion above. In particular, FIG. 2 illustrates an example BLE packet 200, which includes a preamble, an access address, a Protocol Data Unit (PDU), and a cyclic redundancy check (CRC). As shown the PDU in this example packet in turn includes a header and a payload portion. The payload portion then includes various data blocks. As further shown, the PDU could be enhanced as presently contemplated to carry HADM sync-channel information, namely HADM sync-channel configuration information, thus effectively embedding this additional data into the PDU of the message.

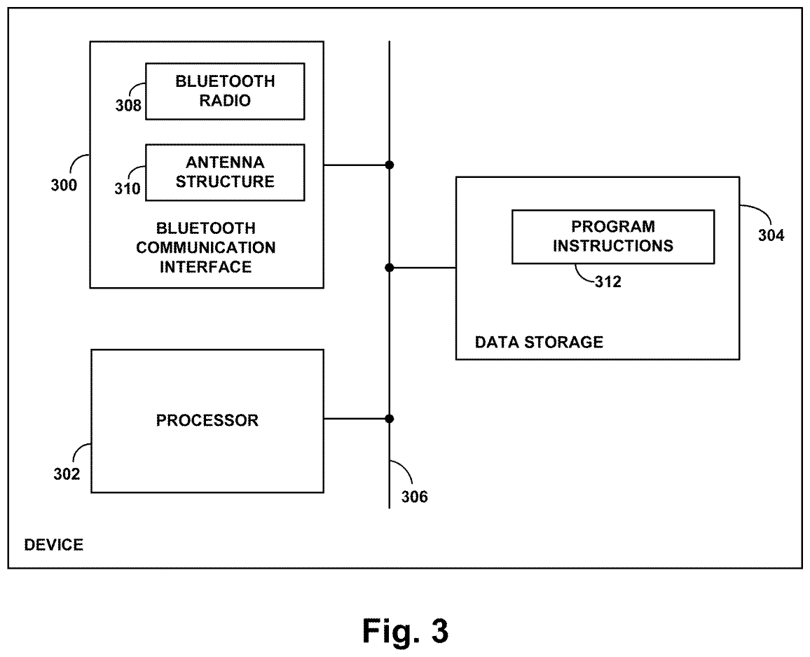

FIG. 3 is next a simplified block diagram of an example device. This device may be the initiator or reflector in the above process, among other possibilities. As shown in FIG. 3, the example device includes a Bluetooth communication interface 300, a processor 302, and non-transitory data storage 304, all of which may be communicatively linked together by a system bus or other connection mechanism 306 and/or may be integrated with each other wholly or partly. As for potential integration of these components, for instance, in an example implementation, the processor 302 and data storage 304 may be part of the Bluetooth communication interface 300. Other arrangements could be possible as well.

As shown, the Bluetooth communication interface 300 of the example device may include a Bluetooth radio 308 and an associated antenna structure 310. The Bluetooth radio 308 may facilitate short-range wireless communication in accordance with the Bluetooth specification overseen by the Bluetooth Special Interest Group (BT SIG), including BLE communications. Further, the antenna structure 310 may be a Bluetooth antenna supporting air-interface transmission and reception of such Bluetooth communications.

The processor 302 may comprise one or more general purpose processors (e.g., microprocessors) and/or one or more special purpose processors (e.g., digital signal processors, application specific integrated circuits, etc.). Further, the non-transitory data storage 304 may comprise one or more volatile and/or non-volatile, removable and/or permanently situated storage components (such as magnetic, optical, flash, RAM, ROM, EPROM, EEPROM, etc.) and may be integrated in whole or in part with the processor 302. Further, as shown, the data storage 304 may embody, encode, hold, or otherwise store program instructions 312, which could be executable by the processor 302 to carry out various device operations such as those described above for instance.

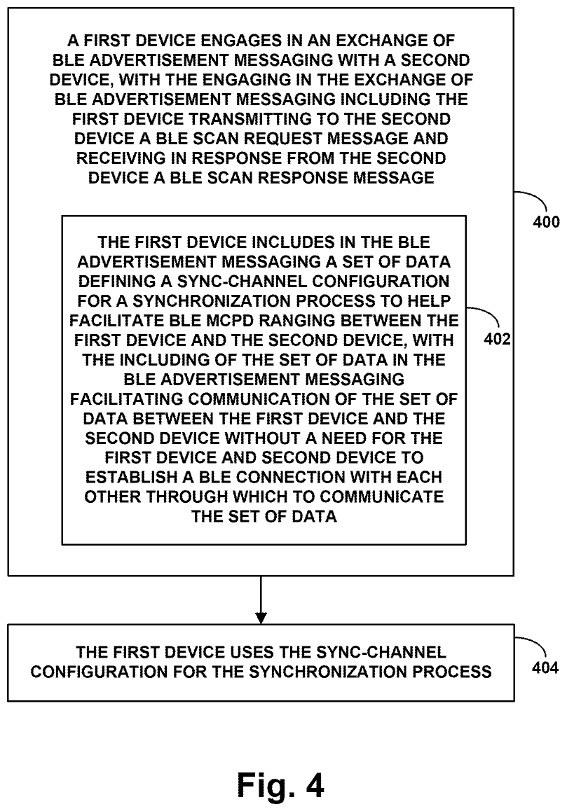

FIG. 4 is next a flow chart illustrating a method that could be carried out in accordance with the present disclosure. As shown in FIG. 4, at block 400, the method includes a first device engaging in an exchange of BLE advertisement messaging with a second device, with the engaging in the exchange of BLE advertisement messaging including the first device transmitting to the second device a BLE scan request message and receiving in response from the second device a BLE scan response message. Further, at block 402, as part of block 400, the first device includes in (e.g., piggybacks onto) the BLE advertisement messaging a set of data defining a sync-channel configuration for a synchronization process to help facilitate BLE MCPD ranging between the first device and the second device, with the including of the set of data in the BLE advertisement messaging facilitating communication of the set of data between the first device and the second device without a need for the first device and second device to establish a BLE connection with each other through which to communicate the set of data. At block 404, the method then includes the first device using the sync-channel configuration for the synchronization process.

In line with the discussion above, the BLE scan request message could be a SCAN_REQ advertisement message, and the BLE scan response message could be a SCAN_RSP advertisement message. Further, the act of including in the BLE advertisement messaging the set of data defining the sync-channel configuration could involve including the set of data in the SCAN_REQ message.

As also discussed above, the act of engaging in the exchange of BLE advertisement messaging could additionally include the first device transmitting to the second device a BLE auxiliary scan request message and receiving in response from the second device a BLE auxiliary scan response message. And in that case, the act of including in the BLE advertisement messaging the set of data defining the sync-channel configuration could alternatively or additionally involve including the set of data in the auxiliary scan request message.

As further discussed above, the set of data that defines the sync-channel configuration could include data indicating one or more BLE channels to be used for the synchronization process, such as data specifying the channel number respectively of each of one or more BLE channels on which the first and second device will engage in the synchronization process with each other. In addition or alternatively, the set of data defining the sync-channel configuration could include data indicating an access code for use in the synchronization process and/or a sync channel map as to multiple sync channels for use in the synchronization process.

Still further, as discussed above, the BLE advertisement messaging could include a PDU for carrying advertisement messaging information between the first device and the second device, in which case the act of including in the BLE advertisement messaging the set of data defining the sync-channel configuration for the synchronization process could involve including the set of data in the PDU of the BLE advertisement messaging, such as a PDU of a SCAN_REQ message for instance.

As additionally discussed above, the first device in this method could be an initiator, and the second device could be a reflector. Further, with the benefit of this process, the first device may also forgo from establishing the BLE connection with the second device, such as by forgoing from sending a CONNECT_REQ message to the second device for instance.

Further, in line with the discussion above, the first device may additionally carry out this process as well with respect to each of one or more other devices as well, possibly establishing different sync-channel configurations respectively with each of the other devices.

For instance, In that case, the first device may engage in an exchange of second BLE advertisement messaging with a third device, with the engaging in the exchange of second BLE advertisement messaging including the first device transmitting to the third device a second BLE scan request message and receiving in response from the third device a second BLE scan response message. Further, the first device may include in the second BLE advertisement messaging a second set of data defining a second sync-channel configuration for a second synchronization process to help facilitate second BLE MCPD ranging between the first device and a third device, with the second sync-channel configuration being different than the first sync-channel configuration, and with the including of the second set of data in the second BLE advertisement messaging facilitating communication of the second set of data between the first device and the third device without a need for the first device and third device to establish a second BLE connection with each other through which to communicate the second set of data. Still further, the first device could use the second sync-channel configuration for the second synchronization process.

As additionally discussed above, the present disclosure also contemplates a device configured to carry out operations such as those discussed above. For instance, the device illustrated in FIG. 3 could carry out these operations.

Further, the present disclosure contemplates a non-transitory computer-readable medium (e.g., one or more volatile and/or non-volatile storage components, such as magnetic, optical, flash, RAM, ROM, EPROM, EEPROM, etc.) having stored thereon program instructions executable by a processor of a device to cause the device to carry out such operations.

Example embodiments have been described above. Those skilled in the art will understand, however, that changes and modifications may be made to these embodiments without departing from the true scope and spirit of the invention.

What is claimed is:

1. A method comprising:
engaging, by a first device, in an exchange of Bluetooth Low Energy (BLE) advertisement messaging with a second device, wherein engaging in the exchange of BLE advertisement messaging includes the first device transmitting to the second device a BLE scan request message and receiving in response from the second device a BLE scan response message;
including, by the first device, in the BLE advertisement messaging, a set of data defining a sync-channel configuration for a synchronization process to help facilitate BLE Multi-Carrier-Phase Difference (MCPD) ranging between the first device and the second device, wherein the including of the set of data in the BLE advertisement messaging facilitates communication of the set of data between the first device and the second device without a need for the first device and second device to establish a BLE connection with each other through which to communicate the set of data; and
using, by the first device, the sync-channel configuration for the synchronization process.

2. The method of claim 1, wherein the BLE scan request message is a SCAN_REQ advertisement message, and wherein the BLE scan response message is a SCAN_RSP advertisement message.

3. The method of claim 2, wherein including in the BLE advertisement messaging the set of data defining the sync-channel configuration comprises including the set of data in the SCAN_REQ message.

4. The method of claim 1, wherein engaging in the exchange of BLE advertisement messaging further includes the first device transmitting to the second device a BLE auxiliary scan request message and receiving in response from the second device a BLE auxiliary scan response message, and wherein including in the BLE advertisement messaging the set of data defining the sync-channel configuration comprises including the set of data in the auxiliary scan request message.

5. The method of claim 1, wherein the set of data defining the sync-channel configuration includes data indicating one or more BLE channels to be used for the synchronization process.

6. The method of claim 1, wherein the set of data defining the sync-channel configuration includes data indicating at least one of (i) an access code for use in the synchronization process or (ii) a sync channel map as to multiple sync channels for use in the synchronization process.

7. The method of claim 1, wherein the BLE advertisement messaging includes a Protocol Data Unit for carrying advertisement messaging information between the first device and the second device, and
wherein including in the BLE advertisement messaging the set of data defining the sync-channel configuration for the synchronization process comprises including the set of data in the PDU of the BLE advertisement messaging.

8. The method of claim 1, wherein the first device is an initiator and the second device is a reflector.

9. The method of claim 1, further comprising forgoing by the first device from establishing the first BLE connection with the second device.

10. The method of claim 1, wherein the BLE advertisement messaging is first BLE advertisement messaging, the BLE scan request is a first BLE scan request, the BLE scan response is a first BLE scan response, the set of data is a first set of data, the sync-channel configuration is a first sync-channel configuration, the synchronization process is a first synchronization process, the BLE MDPD ranging is first BLE MCPD ranging, and the BLE connection is a first BLE connection, the method further comprising:
engaging, by a first device, in an exchange of second BLE advertisement messaging with a third device, wherein engaging in the exchange of second BLE advertisement messaging includes the first device transmitting to the third device a second BLE scan request message and receiving in response from the third device a second BLE scan response message;
including, by the first device, in the second BLE advertisement messaging, a second set of data defining a second sync-channel configuration for a second synchronization process to help facilitate second BLE MCPD ranging between the first device and a third device, wherein the second sync-channel configuration is different than the first sync-channel configuration, and wherein the including of the second set of data in the second BLE advertisement messaging facilitates communication of the second set of data between the first device and the third device without a need for the first device and third device to establish a second BLE connection with each other through which to communicate the second set of data; and
using, by the first device, the second sync-channel configuration for the second synchronization process.

11. A first device comprising:
a Bluetooth radio;
a processor;
non-transitory data storage; and
program instructions stored in the non-transitory data storage and executable by the processor to cause the device to carry out operations including:
engaging in an exchange of Bluetooth Low Energy (BLE) advertisement messaging with a second device, wherein engaging in the exchange of BLE advertisement messaging includes transmitting to the second device a BLE scan request message and receiving in response from the second device a BLE scan response message,
including in the BLE advertisement messaging a set of data defining a sync-channel configuration for a synchronization process to help facilitate BLE Multi-Carrier-Phase Difference (MCPD) ranging between the first device and the second device, wherein the including of the set of data in the BLE advertisement messaging facilitates communication of the set of data between the first device and the second device without a need for the first device and second device to establish a BLE connection with each other through which to communicate the set of data, and
using the sync-channel configuration for the synchronization process.

12. The first device of claim 11, wherein the BLE scan request message is a SCAN_REQ advertisement message, and wherein the BLE scan response message is a SCAN_RSP advertisement message, and wherein including in the BLE advertisement messaging the set of data defining the sync-channel configuration comprises including the set of data in the SCAN_REQ message.

13. The first device of claim 11, wherein the set of data defining the sync-channel configuration includes data indicating one or more BLE channels to be used for the synchronization process.

14. The first device of claim 11, wherein the set of data defining the sync-channel configuration includes data indicating at least one of (i) an access code for use in the synchronization process or (ii) a sync channel map as to multiple sync channels for use in the synchronization process.

15. The first device of claim 1, wherein the BLE advertisement messaging includes a Protocol Data Unit for carrying advertisement messaging information between the first device and the second device, and
wherein including in the BLE advertisement messaging the set of data defining the sync-channel configuration for the synchronization process comprises including the set of data in the PDU of the BLE advertisement messaging.

16. The first device of claim 1, wherein the first device is an initiator and the second device is a reflector.

17. The first device of claim 1, wherein the operations additionally include forgoing from establishing the first BLE connection with the second device.

18. A non-transitory computer-readable medium having stored thereon program instructions executable by a processor of a first device to cause the first device to carry out operations comprising:
engaging in an exchange of Bluetooth Low Energy (BLE) advertisement messaging with a second device, wherein engaging in the exchange of BLE advertisement messaging includes transmitting to the second device a BLE scan request message and receiving in response from the second device a BLE scan response message;
including in the BLE advertisement messaging a set of data defining a sync-channel configuration for a synchronization process to help facilitate BLE Multi-Carrier-Phase Difference (MCPD) ranging between the first device and the second device, wherein the including of the set of data in the BLE advertisement messaging facilitates communication of the set of data between the first device and the second device without a need for the first device and second device to establish a BLE connection with each other through which to communicate the set of data; and
using the sync-channel configuration for the synchronization process.

19. The non-transitory computer-readable medium of claim 18, wherein the BLE scan request message is a SCAN_REQ advertisement message, and wherein the BLE scan response message is a SCAN_RSP advertisement message, and wherein including in the BLE advertisement messaging the set of data defining the sync-channel configuration comprises including the set of data in the SCAN_REQ message.

20. The non-transitory computer-readable medium of claim 18, wherein the set of data defining the sync-channel configuration includes data indicating one or more BLE channels to be used for the synchronization process.
